(19) United States
(12) Patent Application Publication
(10) Pub. No.: US 2018/0063849 A1
(43) Pub. Date: Mar. 1, 2018

(54) TRANSMISSION AND DETECTION METHODS FOR RANGE EXTENSION

(71) Applicant: QUALCOMM Incorporated, San Diego, CA (US)

(72) Inventors: Ahmad Abdulrahman Mohammed, San Jose, CA (US); Louay Jalloul, San Jose, CA (US)

(21) Appl. No.: 15/248,257

(22) Filed: Aug. 26, 2016

(51) Int. Cl. H04W 72/08; H04L 1/00; H04L 12/26

(52) U.S. Cl. CPC H04W 72/082; H04W 84/12; H04L 43/16; H04L 1/0047

(57) ABSTRACT

Systems and methods are disclosed for decoding wireless signals. For example, a wireless device may receive a wireless signal, de-interleave the received wireless signal to produce a first encoded signal and a second encoded signal, generate a first set of a priori log likelihood ratios (LLRs) by decoding and de-interleaving the first encoded signal, and recover a set of information bits from the received wireless signal based at least in part on the second encoded signal and the first set of a priori LLRs.

### TECHNICAL FIELD

The example embodiments relate generally to wireless networks, and specifically to transmitting and receiving wireless signals having low code rates.

### BACKGROUND OF RELATED ART

A wireless local area network (WLAN) may be formed by one or more access points (APs) that provide a shared wireless communication medium for use by a number of client devices or stations (STAs). Interference in the wireless medium and/or distances between devices may cause performance degradation in wireless communications between an AP and a STA. To overcome such performance degradation, the APs and/or STAs may implement range extension protocols when transmitting and/or receiving wireless signals. For example, range extension protocols may improve the performance of wireless communications by introducing redundancy into the transmitted signals. However, this also reduces the rate at which information bits may be transmitted.

To measure the degree of redundancy introduced, a code rate (r) may represent the ratio of information bits transmitted to total bits transmitted. Current standards do not support code rates below a minimum of ½, which may limit the effectiveness of range extension protocols in certain environments (e.g., especially for low signal-to-noise ratio). Accordingly, it may be desirable to improve the resiliency of wireless communications to signal degradation while allowing for range extension protocols with lower code rates.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Apparatus and methods are disclosed for decoding wireless signals. In one example, a method for decoding wireless signals is disclosed. The method may include receiving a wireless signal, de-interleaving the received wireless signal to produce a first encoded signal and a second encoded signal, generating a first set of a priori log likelihood ratios (LLRs) by decoding and de-interleaving the first encoded signal, and recovering a set of information bits from the received wireless signal based at least in part on the second encoded signal and the first set of a priori LLRs.

In another example, a wireless device is disclosed. The wireless device may include one or more processors, one or more transceivers, and a memory storing one or more programs comprising instructions that, when executed by the one or more processors, cause the wireless device to receive and decode a wireless signal by performing operations including: receiving the wireless signal, de-interleaving the received wireless signal to produce a first encoded signal and a second encoded signal, generating a first set of a priori log likelihood ratios (LLRs) by decoding and de-interleaving the first encoded signal, and recovering a set of information bits from the received wireless signal based at least in part on the second encoded signal and the first set of a priori LLRs.

In another example, a wireless device for receiving and decoding a wireless signal is disclosed. The wireless device may include means for receiving a wireless signal, means for de-interleaving the received wireless signal to produce a first encoded signal and a second encoded signal, means for generating a first set of a priori log likelihood ratios (LLRs) by decoding and de-interleaving the first encoded signal, and means for recovering a set of information bits from the received wireless signal based at least in part on the second encoded signal and the first set of a priori LLRs.

### BRIEF DESCRIPTION OF THE DRAWINGS

The example embodiments are illustrated by way of example and are not intended to be limited by the figures of the accompanying drawings, where:

FIG. 1 shows a block diagram of a wireless system within which the example embodiments may be implemented.

FIG. 2 shows a block diagram of a wireless station (STA) in accordance with example embodiments.

FIG. 3 shows a block diagram of an access point (AP) in accordance with example embodiments.

FIG. 4 shows a block diagram of a system for supporting range extension in wireless devices, according to the example embodiments.

FIG. 5 shows a block diagram of another system for supporting range extension in wireless devices, according to the example embodiments.

FIG. 6 shows an illustrative flow chart depicting example operations for range extension, in accordance with some embodiments.

Like reference numerals refer to corresponding parts throughout the drawing figures.

### DETAILED DESCRIPTION

The example embodiments are described below in the context of WLAN systems for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of STAs, the example embodiments are equally applicable to other WLAN systems including, for example, multiple WLANs, peer-to-peer (or Independent Basic Service Set) systems, Wi-Fi Direct systems, and/or Hotspots. In addition, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer (PHY) convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means connected directly to or connected through one or more intervening components or circuits. The term “associated AP” refers to an AP with which a given STA is associated (e.g., there is an established communication channel or link between the AP and the given STA). The term “non-associated AP” refers to an AP with which a given STA is not associated (e.g., there is not an established communication channel or link between the AP and the given STA, and thus the AP and the given STA may not yet exchange data frames). The term “associated STA” refers to a STA that is associated with a given AP, and the term “non-associated STA” refers to a STA that is not associated with the given AP.

Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. The example embodiments are not to be construed as limited to specific examples described herein but rather to include within their scopes all embodiments defined by the appended claims.

As mentioned above, wireless devices may experience performance degradation in environments with poor signal to noise ratio (SNR). Current wireless standards, such as IEEE 802.11ax, require support for range extension protocols. For example, conventional range extension techniques employ redundancy (e.g., by repeating information bits) to counter such performance degradation. However, current standards do not support code rates less than ½. Accordingly, it may be desirable to improve the resiliency of wireless communications to signal degradation while supporting code rates below the minimum supported code rate.

The range extension techniques of the example embodiments may employ structured coding techniques instead of the repetition provided in conventional techniques. For at least some embodiments, the range extension techniques may employ parallel concatenation of FEC codes to provide the structured coding. For other embodiments, the range extension techniques may employ serial concatenation of FEC codes to provide the structured coding. Such techniques may provide better resiliency to signal degradation while supporting lower coding rates (e.g., including code rates below the minimum value supported by the current standards). The example embodiments may also support iterative decoding (e.g., if a receiver time window allows), which may provide additional performance improvement. Further, the example embodiments may allow for the use of conventional bit/tone interleavers without requiring special bit logic or tone allocation, as is required by conventional range extension techniques. These and other details of the example embodiments, which provide one or more technical solutions to the aforementioned technical problems, are described in more detail below.

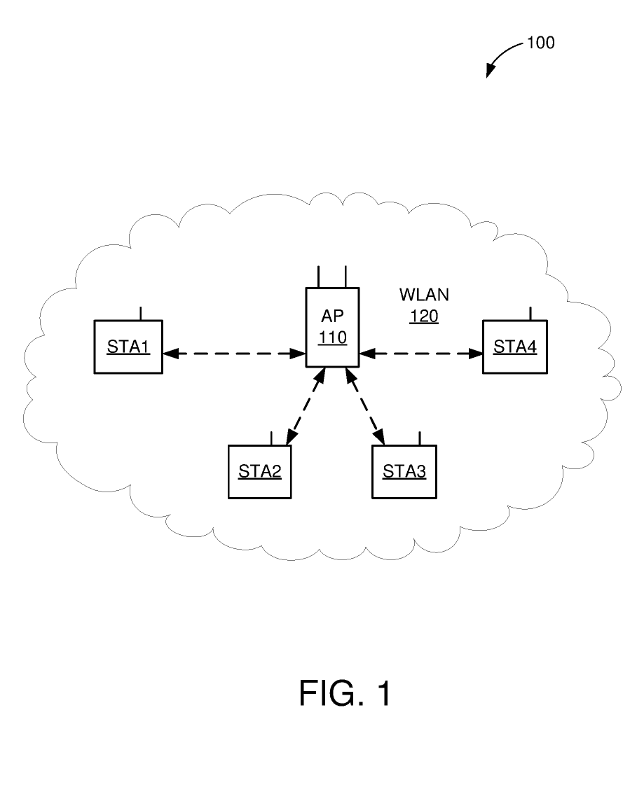

FIG. 1 is a block diagram of a wireless system 100 within which the example embodiments may be implemented. The wireless system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique media access control (MAC) address that is programmed therein by, for example, the manufacturer of the access point. Similarly, each of stations STA1-STA4 is also assigned a unique MAC address. For some embodiments, the wireless system 100 may correspond to a multiple-input multiple-output (MIMO) wireless network, and may support single-user MIMO (SU-MIMO) and multi-user (MU-MIMO) communications. Further, although the WLAN 120 is depicted in FIG. 1 as an infrastructure BSS, for other example embodiments, WLAN 120 may be an IBSS, an ad-hoc network, or a peer-to-peer (P2P) network (e.g., operating according to the Wi-Fi Direct protocols).

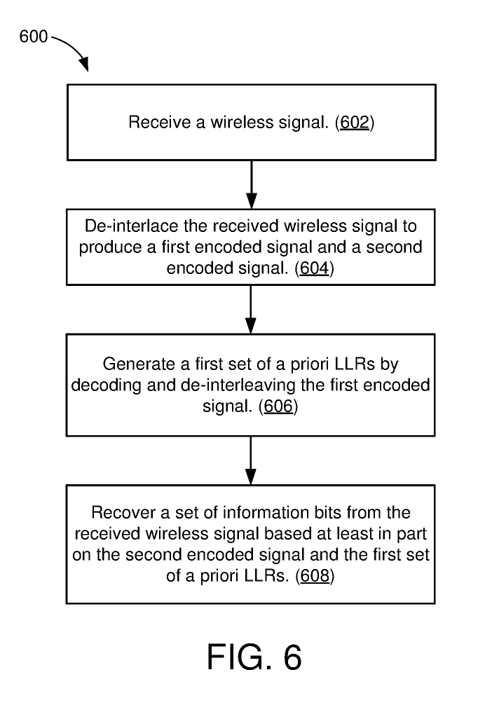

Each of stations STA1-STA4 may be any suitable Wi-Fi enabled wireless device including, for example, a cell phone, personal digital assistant (PDA), tablet device, laptop computer, or the like. Each of stations STA1-STA4 may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each of stations STA1-STA4 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 6.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. For at least one embodiment, AP 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 6.

For the stations STA1-STA4 and/or AP 110, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band, within a 5 GHz frequency band in accordance with the IEEE 802.11 specification, and/or within a 60 GHz frequency band. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within each of the stations STA1-STA4 may be any technically feasible transceiver such as a ZigBee transceiver described by a specification from the ZigBee specification, a WiGig transceiver, and/or a HomePlug transceiver described a specification from the HomePlug Alliance.

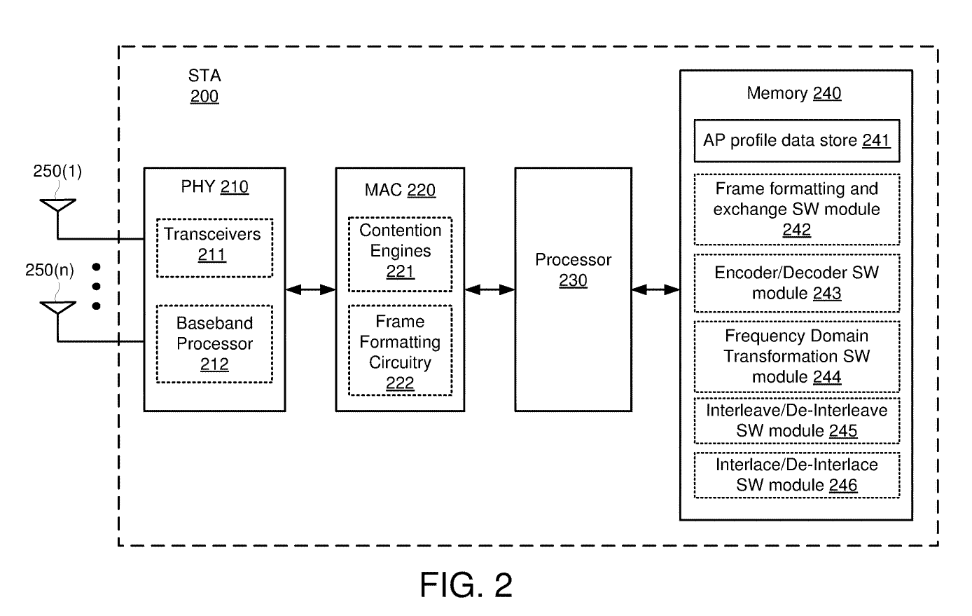

FIG. 2 shows an example STA 200 that may be an embodiment of one of the stations STA1-STA4 of FIG. 1. The STA 200 may include a PHY device 210 including at least a number of transceivers 211 and a baseband processor 212, a MAC 220 including at least a number of contention engines 221 and frame formatting circuitry 222, a processor 230, a memory 240, and a number of antennas 250(1)-250(n). The transceivers 211 may be coupled to antennas 250(1)-250(n), either directly or through an antenna selection circuit (not shown for simplicity). The transceivers 211 may be used to transmit signals to and receive signals from AP 110 and/or other STAs (see also FIG. 1), and may be used to scan the surrounding environment to detect and identify nearby access points and/or other STAs (e.g., within wireless range of STA 200). Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, for example embodiments, the STA 200 may be configured for MIMO operations. The MIMO operations may include single-user MIMO (SU-MIMO) operations and multi-user MIMO (MU-MIMO) operations.

The baseband processor 212 may be used to process signals received from processor 230 and/or memory 240 and to forward the processed signals to transceivers 211 for transmission via one or more of antennas 250(1)-250(n), and may be used to process signals received from one or more of antennas 250(1)-250(n) via transceivers 211 and to forward the processed signals to processor 230 and/or memory 240.

For purposes of discussion herein, MAC 220 is shown in FIG. 2 as being coupled between PHY device 210 and processor 230. For actual embodiments, PHY device 210, MAC 220, processor 230, and/or memory 240 may be connected together using one or more buses (not shown for simplicity).

The contention engines 221 may contend for access to one more shared wireless mediums, and may also store packets for transmission over the one more shared wireless mediums. The STA 200 may include one or more contention engines 221 for each of a plurality of different access categories. For other embodiments, the contention engines 221 may be separate from MAC 220. For still other embodiments, the contention engines 221 may be implemented as one or more software modules (e.g., stored in memory 240 or stored in memory provided within MAC 220) containing instructions that, when executed by processor 230, perform the functions of contention engines 221.

The frame formatting circuitry 222 may be used to create and/or format frames received from processor 230 and/or memory 240 (e.g., by adding MAC headers to PDUs provided by processor 230), and may be used to re-format frames received from PHY device 210 (e.g., by stripping MAC headers from frames received from PHY device 210).

Memory 240 may include an AP profile data store 241 that stores profile information for a plurality of APs. The profile information for a particular AP may include information including, for example, the AP's SSID, MAC address, channel information, received signal strength indicator (RSSI) values, goodput values, channel state information (CSI), supported data rates, connection history with the AP, a trustworthiness value of the AP (e.g., indicating a level of confidence about the AP's location, etc.), and any other suitable information pertaining to or describing the operation of the AP.

Memory 240 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange SW module 242 to facilitate the creation and exchange of any suitable frames (e.g., data frames, action frames, and management frames) used in communications between STA 200 and other wireless devices (e.g., as described for one or more operations of FIG. 6);
an encoder/decoder SW module 243 to facilitate the encoding and decoding of data using suitable forward error correction (FEC) coding techniques such as convolution block coding, low-density parity-check (LDPC), etc. (e.g., as described for one or more operations of FIG. 6);
a frequency domain transformation SW module 244 to facilitate the transformation of signals between time-domain and frequency-domain representations using suitable techniques such as fast Fourier transformation (FFT) and inverse FFT (IFFT) techniques (e.g., as described for one or more operations of FIG. 6);
an interleave/de-interleave software module 245 to facilitate the interleaving and de-interleaving of code bits and bit streams (e.g., as described for one or more operations of FIG. 6); and
an interlace/de-interlace SW module 246 to facilitate the interlacing of two or more parallel streams of code bits into a single stream of code bits, and to facilitate the de-interlacing of a single stream of code bits into two or more parallel streams of code bits (e.g., as described for one or more operations of FIG. 6).
   Each software module includes instructions that, when executed by processor 230, cause STA 200 to perform the corresponding functions. The non-transitory computer-readable medium of memory 240 thus includes instructions for performing all or a portion of the operations depicted in FIG. 6.

Processor 230, which is shown in the example of FIG. 2 as coupled to PHY device 210, MAC 220, and memory 240, may be any suitable one or more processors capable of executing scripts or instructions of one or more software programs stored in STA 200 (e.g., within memory 240). For example, processor 230 may execute the frame formatting and exchange SW module 242 to facilitate the creation and exchange of any suitable frames (e.g., data frames, action frames, and management frames) used in communications between STA 200 and other wireless devices. Processor 230 may execute the encoder/decoder SW module 243 to facilitate the encoding and decoding of data using suitable FEC coding techniques such as convolution block coding, LDPC, etc. Processor 230 may execute the frequency domain transformation SW module 244 to facilitate the transformation of signals between time-domain and frequency-domain representations using suitable techniques such as fast FFT and IFFT techniques. Processor 230 may execute the interleave/de-interleave SW module 245 to facilitate the interleaving and de-interleaving of code bits and bit streams. Processor 230 may execute the interlace/de-interlace SW module 246 to facilitate the interlacing of two or more parallel streams of code bits into a single stream of code bits, and to facilitate the de-interlacing of a single stream of code bits into two or more parallel streams of code bits.

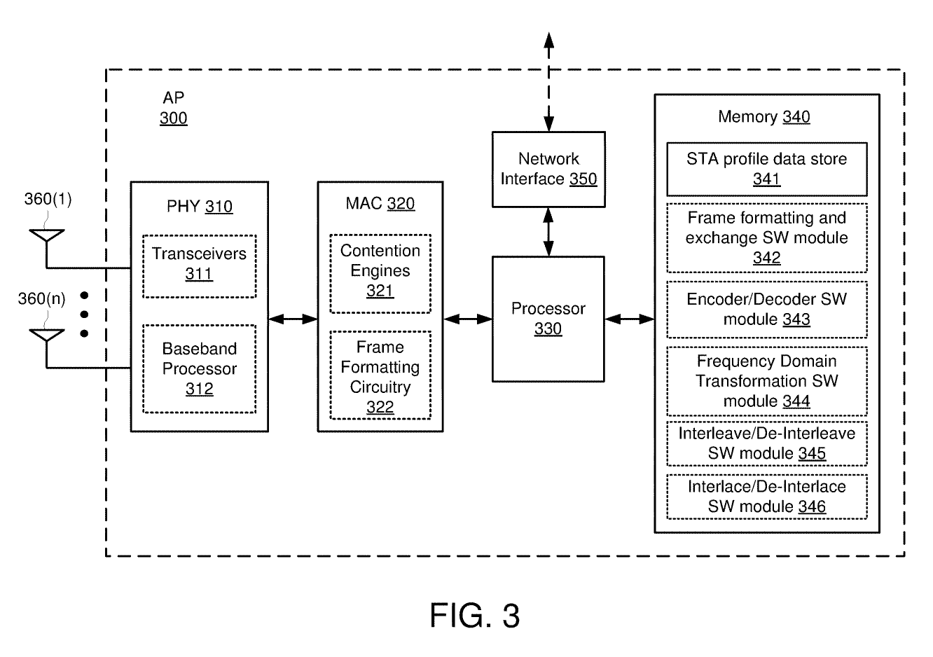

FIG. 3 shows an example AP 300 that may be one embodiment of the AP 110 of FIG. 1. AP 300 may include a PHY device 310 including at least a number of transceivers 311 and a baseband processor 312, a MAC 320 including at least a number of contention engines 321 and frame formatting circuitry 322, a processor 330, a memory 340, a network interface 350, and a number of antennas 360(1)-360(n). The transceivers 311 may be coupled to antennas 360(1)-360(n), either directly or through an antenna selection circuit (not shown for simplicity). The transceivers 311 may be used to communicate wirelessly with one or more STAs, with one or more other APs, and/or with other suitable devices. Although not shown in FIG. 3 for simplicity, the transceivers 311 may include any number of transmit chains to process and transmit signals to other wireless devices via antennas 360(1)-360(n), and may include any number of receive chains to process signals received from antennas 360(1)-360(n). Thus, for example embodiments, the AP 300 may be configured for MIMO operations including, for example, SU-MIMO operations and MU-MIMO operations.

The baseband processor 312 may be used to process signals received from processor 330 and/or memory 340 and to forward the processed signals to transceivers 311 for transmission via one or more of antennas 360(1)-360(n), and may be used to process signals received from one or more of antennas 360(1)-360(n) via transceivers 311 and to forward the processed signals to processor 330 and/or memory 340.

The network interface 350 may be used to communicate with a WLAN server (not shown for simplicity) either directly or via one or more intervening networks and to transmit signals.

For purposes of discussion herein, MAC 320 is shown in FIG. 3 as being coupled between PHY device 310 and processor 330. For actual embodiments, PHY device 310, MAC 320, processor 330, memory 340, and/or network interface 350 may be connected together using one or more buses (not shown for simplicity).

The contention engines 321 may contend for access to the shared wireless medium, and may also store packets for transmission over the shared wireless medium. For some embodiments, AP 300 may include one or more contention engines 321 for each of a plurality of different access categories. For other embodiments, the contention engines 321 may be separate from MAC 320. For still other embodiments, the contention engines 321 may be implemented as one or more software modules (e.g., stored in memory 340 or within memory provided within MAC 320) containing instructions that, when executed by processor 330, perform the functions of contention engines 321.

The frame formatting circuitry 322 may be used to create and/or format frames received from processor 330 and/or memory 340 (e.g., by adding MAC headers to PDUs provided by processor 330), and may be used to re-format frames received from PHY device 310 (e.g., by stripping MAC headers from frames received from PHY device 310).

Memory 340 may include a STA profile data store 341 that stores profile information for a plurality of STAs. The profile information for a particular STA may include information including, for example, its MAC address, previous AP-initiated channel sounding requests, supported data rates, connection history with AP 300, and any other suitable information pertaining to or describing the operation of the STA.

Memory 340 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange SW module 342 to facilitate the creation and exchange of any suitable frames (e.g., data frames, action frames, and management frames) used in communications between AP 300 and other wireless devices (e.g., as described for one or more operations of FIG. 6);
an encoder/decoder SW module 343 to facilitate the encoding and decoding of data using suitable FEC coding techniques such as convolution block coding, LDPC, etc. (e.g., as described for one or more operations of FIG. 6);
a frequency domain transformation SW module 344 to facilitate the transformation of signals between time-domain and frequency-domain representations using suitable techniques such as FFT and IFFT techniques (e.g., as described for one or more operations of FIG. 6);
an interleave/de-interleave SW module 345 to facilitate the interleaving and de-interleaving of code bits and bit streams (e.g., as described for one or more operations of FIG. 6); and
an interlace/de-interlace SW module 346 to facilitate the interlacing of two or more parallel streams of code bits into a single stream of code bits, and to facilitate the de-interlacing of a single stream of code bits into two or more parallel streams of code bits (e.g., as described for one or more operations of FIG. 6).
   Each software module includes instructions that, when executed by processor 330, cause AP 300 to perform the corresponding functions. The non-transitory computer-readable medium of memory 340 thus includes instructions for performing all or a portion of the operations depicted in FIG. 6.

Processor 330, which is shown in the example of FIG. 3 as coupled to PHY device 310, MAC 320, memory 340, and network interface 350, may be any suitable one or more processors capable of executing scripts or instructions of one or more software programs stored in AP 300 (e.g., within memory 340). For example, processor 330 may execute the frame formatting and exchange SW module 342 to facilitate the creation and exchange of any suitable frames (e.g., data frames, action frames, and management frames) used in communications between AP 300 and other wireless devices. Processor 330 may execute the encoder/decoder SW module 343 to facilitate the encoding and decoding of data using suitable FEC coding techniques such as convolution block coding, LDPC, etc. Processor 330 may execute the frequency domain transformation SW module 344 to facilitate the transformation of signals between time-domain and frequency-domain representations using suitable techniques such as FFT and IFFT techniques. Processor 330 may execute the interleave/de-interleave SW module 345 to facilitate the interleaving and de-interleaving of code bits and bit streams. Processor 330 may execute the interlace/de-interlace SW module 346 to facilitate the interlacing of two or more parallel streams of code bits into a single stream of code bits, and to facilitate the de-interlacing of a single stream of code bits into two or more parallel streams of code bits.

As described above, current wireless standards require the support of range extension techniques so that wireless devices may experience less performance degradation in environments having poor SNR. Conventional techniques may support range extension through redundancy provided by repeating code bits. For example, conventional techniques may encode and interleave a set of information bits, and then repeat them, generating two copies of the encoded and interleaved information bits. One copy is modulated and assigned to a first half of the channel spectrum, while bit logic is applied to the second copy before it is modulated and assigned to a second half of the channel spectrum. The bit logic may apply flip, swap or perform another bit level operation on the second copy. Assigning the two modulated signals to different halves of the channel spectrum provides diversity through greater frequency separation. Conventional receivers may apply similar techniques recover the information bits.

Conventional methods for range extension, in wireless communications, may employ code bit repetition, bit logic, and by separating the redundant signals in the channel spectrum. However, to further reduce performance degradation in poor-SNR environments, it may be desirable to provide more structured redundancy than simple repetition. It may also be desirable to support this structured redundancy at code rates below the conventionally supported minimum of ½. Accordingly, the example embodiments provide for range extensions techniques that implement structured redundancy through the use of concatenation of FEC codes. This concatenation may be parallel concatenation or serial concatenation, as discussed below.

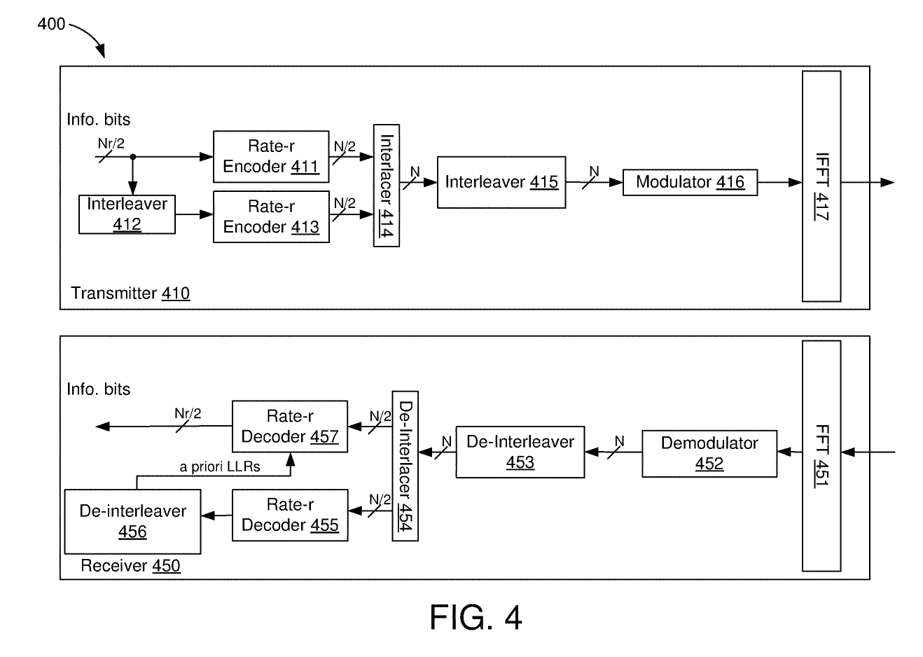

FIG. 4 shows a block diagram 400 of a transmitter 410 and a receiver 450 employing parallel concatenation techniques, in accordance with the example embodiments. The transmitter 410 and receiver 450 may be provided within a wireless device, such as a STA or an AP, to transmit and receive wireless signals, respectively. The transmitter 410 includes rate-r encoders 411 and 413, interleavers 412 and 415, an interlacer 414, a modulator 416, and an IFFT 417. The receiver 450 includes an FFT 451, a demodulator 452, de-interleavers 453 and 456, a de-interlacer 454, and rate-r decoders 455 and 457.

A set of N*r/2 information bits (e.g., where r is the code rate and N is a positive integer) may be provided as inputs to both the rate-r encoder 411 and the interleaver 412, which interleaves the information bits and then provides the interleaved information bits to rate-r encoder 413. Each of the rate-r encoders 411 and 413 encodes its respective information bits according to an FEC coding technique and outputs a correspond set of N/2 code bits. The N/2 code bits from each of rate-r encoder 411 and rate-r encoder 413 are then provided to interlacer 414, which interlaces the two streams of N/2 code bits to generate a single stream of N code bits, which is provided to interleaver 415. The interleaver 415 interleaves the stream of N code bits and provides the interleaved code bits to modulator 416, and then to IFFT 417, which generates a time-domain signal for transmission. Compared to conventional transmitters, transmitter 410 may use a conventional tone interleaver 415 and modulator 416 (e.g., in lieu of more complicated structures required for bit logic and tone mapping).

Receiver 450 may recover information bits from a signal transmitted in accordance with the encoding techniques implemented by the transmitter 410. For example, FFT 451 may receive a time-domain signal and may transform the time-domain signal into a frequency-domain signal. The frequency-domain signal may be demodulated by demodulator 452, and then de-interleaved by de-interleaver 453. The de-interleaved signal then passes to de-interlacer 454, which splits the de-interleaved signal into two encoded signals. A first encoded signal is decoded by rate-r decoder 455, and de-interleaved by de-interleaver 456. The second encoded signal is sent to rate-r decoder 457. In example embodiments, rate-r decoder 457 may use the de-interleaved and decoded first encoded signal (e.g., the output of de-interleaver 456) as a priori log likelihood ratios (LLRs) to aid in the decoding of the second encoded signal. In this manner, the receiver rate-r decoder 457 may recover the N*r/2 information bits that were originally transmitted by a transmitting device.

By employing parallel concatenation techniques to provide structured redundancy (e.g., as described above with respect to FIG. 4), the example embodiments may provide a number of advantages over conventional range extension techniques. For example, the structured redundancy of the example embodiments may allow for greater performance gains over conventional range extension techniques. More specifically, by implementing such structured redundancy in wireless signal transmissions, the transmitted signals may be more resilient to signal degradation and offer more robust performance at low SNR.

Further, the example embodiments may be implemented without some of the special modules required by conventional techniques. For example, conventional range extension techniques use bit logic and tone allocation techniques to map and de-map signals to and from different halves of a channel spectrum. In contrast, by employing parallel concatenation, the example embodiments do not require special bit logic or tone allocation (e.g., and may instead use standard interleaver and tone allocation techniques).

Although FIG. 4 shows rate-r encoders 411 and 413 as separate modules, according to some embodiments the transmitter 410 may include a single rate-r encoder that may be sequentially used to provide the functionality of both rate-r encoders 411 and 413. Similarly, while FIG. 4 shows rate-r decoders 455 and 457 as separate modules, in some embodiments the receiver 450 may include a single rate-r decoder that may be sequentially used to provide the functionality of both rate-r decoders 455 and 457.

Still further, the structured coding techniques may not require any additional processing time compared to conventional range extension techniques. For example, if the code rate r=½, the example embodiments may decompose the N*r/2 information bits into parallel streams of N/4 code bits. The time required to encode and/or decode N/4 bits is approximately half the time needed to encode and/or decode N/2 bits, which is already supported by current wireless standards. Similarly, if r=¼, the example embodiments may decompose the N*r/2 information bits into parallel streams of N/8 code bits. The time required to encode and/or decode N/8 bits is approximately one fourth the time required to encode and/or decode N/2 bits.

According to some embodiments (e.g., if time permits), one or more additional iterations of the decoding process may be performed. For example, although not shown in FIG. 4 for simplicity, the output of rate-r decoder 457 may be further interleaved according to the interleaving technique implemented by interleaver 412. The interleaved output may then be fed back into rate-r decoder 455 and used as a priori LLRs. The output of rate-r decoder 455 may be de-interleaved by de-interleaver 456, and used as the decoded information bits. Thus, as long as time permits, additional iterations may be performed.

In some embodiments, the receiver 450 may be capable of operating in a normal mode and in a low-power mode. In the normal mode, the receiver 450 may operate as described above. However, the rate-r decoder 455 and de-interleaver 456 may not be used when operating in low-power mode. In some embodiments, the rate-r decoder 455 and de-interleaver 456 may enter a low-power state when receiver 450 is in the low-power mode. As a result, the a priori LLRs may be suppressed, and the decoding of the information bits may be performed exclusively by rate-r decoder 457 (e.g., without the aid of a priori LLRs provided by rate-r decoder 455 and de-interleaver 456).

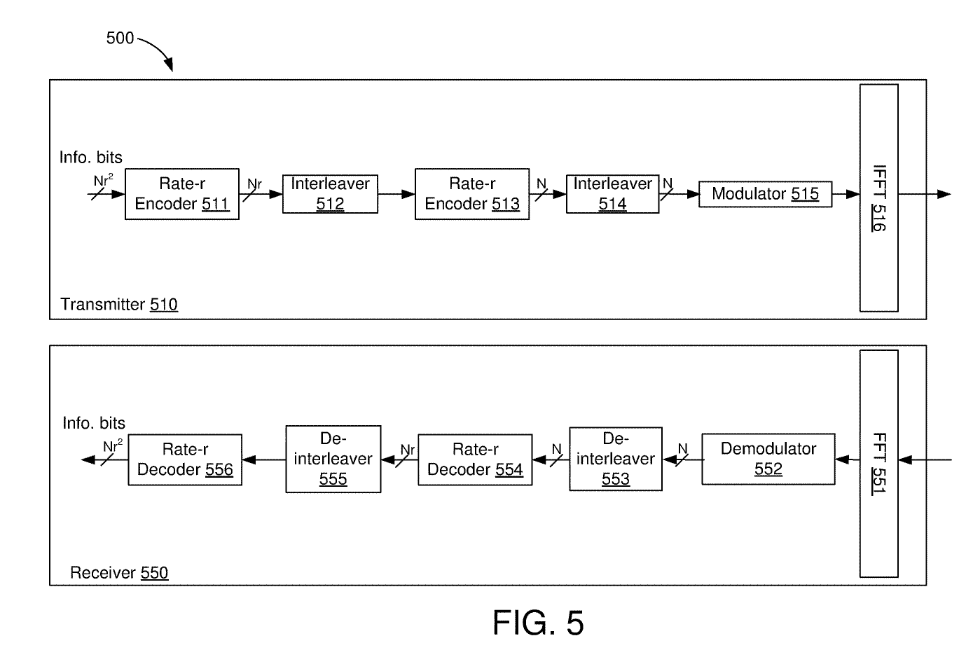

Although transmitter 410 and receiver 450 are depicted in FIG. 4 as having two rate-r encoders and decoders, respectively, some embodiments may include additional encoders and/or decoders (not shown for simplicity). For example, according to some embodiments, a transmitter may include three rate-r encoders. In such an embodiment, the transmitter may generate three copies of the information bits (e.g., instead of two, as shown in FIG. 5). A first copy may be encoded without interleaving, while the second and third copies may each be interleaved prior to encoding. Then the first copy, the interleaved second copy, and the interleaved third copy may be interlaced, interleaved, modulated, and tone-mapped for transmission over a wireless medium.

A corresponding receiver may include three rate-r decoders. For example, a de-interlacer may split a stream of received code bits into three encoded signals, which may be provided to the three rate-r decoders, respectively. For some embodiments, the receiver may operate in at least a normal mode, and may be capable of operating in one or more low power modes. In the normal mode of operation, a first encoded signal may be decoded and de-interleaved, and may be used as a priori LLRs for decoding a second encoded signal. The decoded second signal may then be de-interleaved and used as a priori LLRs for decoding a third encoded signal, which may be decoded to recover the information bits. In the low-power modes of operation, only one or two of the decoders may be used to determine the information bits, while the unused decoders and de-interleavers may be powered down or placed in a low-power state.

Some other example embodiments may employ serial concatenation to provide the structured coding. FIG. 5 shows a block diagram 500 of a transmitter 510 and a receiver 550 employing serial concatenation techniques, in accordance with these example embodiments. With respect to FIG. 5, N*r² information bits are sent to rate-r encoder 511. The rate-r encoder 511 encodes the information bits according to an FEC coding technique to produce N*r code bits. The code bits are interleaved by interleaver 512 and subsequently encoded by rate-r encoder 513 into N code bits. The N code bits are interleaved by interleaver 514, modulated by modulator 515 and converted to a time-domain signal for transmission by IFFT 516.

Receiver 550 may recover information bits from a signal transmitted in accordance with the encoding techniques implemented by the transmitter 510. For example, FFT 551 may receive a time-domain signal and may transform the time-domain signal into a frequency-domain signal. The frequency domain signal may be demodulated by demodulator 552, and then de-interleaved by de-interleaver 553. The N de-interleaved code bits are decoded by rate-r decoder 554 to generate N*r code bits, which are further de-interleaved by de-interleaver 555. The N*r de-interleaved code bits are then decoded by rate-r decoder 556 to recover the N*r² information bits that were originally transmitted by a transmitting device.

By employing serial concatenation techniques to provide structured redundancy (e.g., as described above with respect to FIG. 5), the example embodiments may provide a number of advantages over conventional range extension techniques. For example, the structured redundancy of the example embodiments may allow for greater performance gains over conventional techniques. More specifically, by implementing such structured redundancy in wires signal transmissions, the transmitted signals may be more resilient to signal degradation and offer more robust performance at low SNR.

Further, the example embodiments may be implemented without some of the special modules required by conventional techniques. For example, conventional range extension techniques use bit logic and tone allocation techniques to map and de-map signals to and from different halves of a channel spectrum. In contrast, by employing serial concatenation, the example embodiments do not require special bit logic or tone allocation (e.g., and may instead use standard interleaver and tone allocation techniques).

Although transmitter 510 and receiver 550 are depicted in FIG. 5 as having two encoders and decoders, respectively, other embodiments employing serial concatenation techniques may include additional encoders and/or decoders (not shown for simplicity). For example, according to some embodiments, a transmitter may include three rate-r encoders and a receiver may include three rate-r decoders, arranged serially (e.g., as shown in FIG. 5). In the transmitter, N*r³ information bits may be encoded by a first rate-r encoder, and interleaved to produce N*r² code bits. The interleaved N*r² code bits may then be encoded by a second rate-r encoder, and interleaved again to produce N*r code bits. The interleaved N*r code bits may then be encoded by a third rate-r encoder to produce N code bits, code bits which may be interleaved, modulated, and tone-mapped for transmission over a wireless medium. Similarly, the receiver may have three rate-r decoders and de-interleavers, and may serially de-interleave and decode received signals to recover the information bits.

Additionally, note that while FIG. 5 shows transmitter 510 to include two rate-r encoders 511 and 513, and shows receiver 550 to include two rate-r decoders 554 and 556, in some embodiments, transmitter 510 may include only one rate-r encoder and/or receiver 550 may include only one rate-r decoder. In such embodiments, an encoder or decoder may be sequentially used to provide the functionality of rate-r encoders 511 and 513 or rate-r decoders 554 and 556, respectively.

FIG. 6 is an illustrative flow chart depicting an example operation 600 for decoding wireless signals, in accordance with some embodiments. The example operation 600 may be performed by any suitable wireless device, such as any of AP 110 or STA1-STA4 of FIG. 1, STA 200 of FIG. 2, or AP 300 of FIG. 3. The wireless device may receive a wireless signal (602). For example, the wireless device may receive the wireless signal via one or more of antennas 250(1)-250(n) of STA 200 of FIG. 2, or one or more of antennas 360(1)-360(n) of AP 300 of FIG. 3. In some examples, receiving the wireless signal may also include transforming the received wireless signal into a frequency-domain signal and demodulating the frequency-domain signal.

The received wireless signal may then be de-interleaved to produce a first encoded signal and a second encoded signal (604). For example, the wireless device may de-interleave the received wireless signal by executing interleave/de-interleave software module 245 of STA 200 of FIG. 2, or by executing interleave/de-interleave software module 345 of AP 300 of FIG. 3. In some examples, the first encoded signal and the second encoded signal are signals encoded according to a forward error correction (FEC) coding scheme, and each of the first encoded signal and the second encoded signal may be independently decodable. For some embodiments, the first encoded signal and the second encoded signal may have a code rate of less than ½. De-interleaving the received wireless signal to generate the first encoded signal and the second encoded signal may further include de-interlacing the de-interleaved wireless signal to produce the first encoded signal and the second encoded signal.

After producing the first encoded signal and the second encoded signal, the wireless device may generate a first set of a priori log likelihood ratios (LLRs) by decoding and de-interleaving the first encoded signal (606). For example, the wireless device may generate the first set of a priori LLRs by executing encoder/decoder software module 243 or interleave/de-interleave software module 245 of STA 200 of FIG. 2, or by executing encoder/decoder software module 343 or interleave/de-interleave software module 345 of AP 300 of FIG. 3. For some embodiments, decoding and de-interleaving the first encoded signal may reverse an encoding and interleaving operation associated with a transmitter of the wireless signal.

The wireless device may then recover a set of information bits from the received wireless signal based at least in part on the second encoded signal and the first set of a priori LLRs (608). For example, the wireless device may recover the set of information bits by executing encoder/decoder software module 243 or interleave/de-interleave software module 245 of STA 200 of FIG. 2, or by executing encoder/decoder software module 343 or interleave/de-interleave software module 345 of AP 300 of FIG. 3. For some embodiments, a common decoder may decode the first encoded signal and determining the set of information bits. In some examples, the set of information bits may be recovered by decoding the second encoded signal based on the first set of a priori LLRs, interleaving the decoded second encoded signal to generate a second set of a priori LLRs, and recovering the set of information bits based at least in part on the second set of a priori LLRs.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of decoding wireless signals, the method being performed by a wireless device and comprising:
receiving a wireless signal;
de-interleaving the received wireless signal to produce a first encoded signal and a second encoded signal;
generating a first set of a priori log likelihood ratios (LLRs) by decoding and de-interleaving the first encoded signal; and
recovering a set of information bits from the received wireless signal based at least in part on the second encoded signal and the first set of a priori LLRs.

2. The method of claim 1, wherein the receiving comprises:
transforming the wireless signal into a frequency-domain signal; and
demodulating the transformed wireless signal.

3. The method of claim 1, wherein the first encoded signal and the second encoded signal are signals corresponding to the set of information bits encoded according to a forward error correction (FEC) coding scheme.

4. The method of claim 1, wherein the recovering comprises:
suppressing one of the first encoded signal or the second encoded signal when operating in a low-power mode; and
decoding the other of the first encoded signal or the second encoded signal to recover the set of information bits.

5. The method of claim 1, wherein the de-interleaving of the received wireless signal comprises:
de-interleaving the received wireless signal to produce a first de-interleaved signal; and
de-interlacing the first de-interleaved signal to produce the first encoded signal and the second encoded signal.

6. The method of claim 1, wherein the recovering comprises:
decoding the second encoded signal based on the first set of a priori LLRs.

7. The method of claim 6, wherein the first encoded signal and the second encoded signal are decoded sequentially by a first decoder.

8. The method of claim 6, wherein the decoding of the second encoded signal comprises:
generating a decoded signal by decoding the second encoded signal using the first set of a priori LLRs;
interleaving the decoded signal to produce a second set of a priori LLRs; and
recovering the set of information bits based at least in part on the second set of a priori LLRs.

9. The method of claim 8, wherein generating the decoded signal, and interleaving the decoded signal are performed in response to a determination that a receiver time window has at least a threshold duration.

10. The method of claim 1, wherein each of the first encoded signal and the second encoded signal is self-decodable.

11. A wireless device, comprising:
one or more processors;
one or more transceivers' and
a memory storing instructions that, when executed by the one or more processors, cause the wireless device to:
receive a wireless signal;
de-interleave the received wireless signal to produce a first encoded signal and a second encoded signal; and
generate a first set of a priori log likelihood ratios (LLRs) by decoding and de-interleaving the first encoded signal; and
recover a set of information bits from the received wireless signal based at least in part on the second encoded signal and the first set of a priori LLRs.

12. The wireless device of claim 11, wherein execution of the instructions to receive the wireless signal causes the wireless device to:
transform the wireless signal into a frequency-domain signal; and
demodulate the transformed wireless signal.

13. The wireless device of claim 11, wherein the first encoded signal and the second encoded signal are signals encoded according to a forward error correction (FEC) coding scheme.

14. The wireless device of claim 11, wherein execution of the instructions to recover the set of information bits causes the wireless device to:
suppress one of the first encoded signal or the second encoded signal when operating in a low-power mode; and
decode the unsuppressed encoded signal to recover the set of information bits.

15. The wireless device of claim 11, wherein execution of the instructions to de-interleave the received wireless signal causes the wireless device to:
de-interleave the received wireless signal to produce a first de-interleaved signal; and
de-interlace the first de-interleaved signal to produce the first encoded signal and the second encoded signal.

16. The wireless device of claim 11, wherein execution of the instructions to recover the set of information bits causes the wireless device to:
decode the second encoded signal based on the first set of a priori LLRs.

17. The wireless device of claim 16, wherein decoding the first encoded signal and decoding the second encoded signal are sequentially performed by a first decoder.

18. The wireless device of claim 16, wherein execution of the instructions to decode the second encoded signal causes the wireless device to:
generate a decoded signal by decoding the second encoded signal using the first set of a priori LLRs;
interleave the decoded signal to produce a second set of a priori LLRs; and
recover the set of information bits based at least in part on the second set of a priori LLRs.

19. The wireless device of claim 18, wherein generating the decoded signal, and interleaving the decoded signal are performed in response to a determination that a receiver time window has at least a threshold duration.

20. The wireless device of claim 11, wherein each of the first encoded signal and the second encoded signal is self-decodable.

21. A non-transitory computer-readable medium storing instructions that, when executed by one or more processors of a wireless device, cause the wireless device to:
receive a wireless signal;
de-interleave the received wireless signal to produce a first encoded signal and a second encoded signal; and
generate a first set of a priori log likelihood ratios (LLRs) by decoding and de-interleaving the first encoded signal; and
recover a set of information bits from the received wireless signal based at least in part on the second encoded signal and the first set of a priori LLRs.

22. The non-transitory computer-readable medium of claim 21, wherein execution of the instructions to receive the wireless signal cause the wireless device to:
transform the wireless signal into a frequency-domain signal; and
demodulate the transformed wireless signal.

23. The non-transitory computer-readable medium of claim 21, wherein the first encoded signal and the second encoded signal are signals encoded according to a forward error correction (FEC) coding scheme.

24. The non-transitory computer-readable medium of claim 21, wherein execution of the instructions to recover the set of information bits causes the wireless device to:
suppress one of the first encoded signal or the second encoded signal when operating in a low-power mode; and
decode the unsuppressed encoded signal to recover the set of information bits.

25. The non-transitory computer-readable medium of claim 21, wherein execution of the instructions to de-interleave the received wireless signal causes the wireless device to:
de-interleave the received wireless signal to produce a first de-interleaved signal; and
de-interlace the first de-interleaved signal to produce the first encoded signal and the second encoded signal.

26. The non-transitory computer-readable medium of claim 21, wherein execution of the instructions to recover the set of information bits causes the wireless device to:
decode the second encoded signal based on the first set of a priori LLRs.

27. The non-transitory computer-readable medium of claim 21, wherein execution of the instructions to decode the second encoded signal causes the wireless device to:
generate a decoded signal by decoding the second encoded signal using the first set of a priori LLRs;
interleave the decoded signal to produce a second set of a priori LLRs; and
recover the set of information bits based at least in part on the second set of a priori LLRs.

28. The non-transitory computer-readable medium of claim 27, wherein generating the decoded signal, and interleaving the decoded signal are performed in response to a determination that a receiver time window has at least a threshold duration.

29. The non-transitory computer-readable medium of claim 21, wherein each of the first encoded signal and the second encoded signal is self-decodable.

30. A wireless device comprising:
means for receiving a wireless signal;
means for de-interleaving the received wireless signal to produce a first encoded signal and a second encoded signal;
generating a first set of a priori log likelihood ratios (LLRs) by decoding and de-interleaving the first encoded signal; and
recovering a set of information bits from the received wireless signal based at least in part on the second encoded signal and the first set of a priori LLRs.
